(19) United States
(12) Patent Application Publication
(10) Pub. No.: US 2006/0189704 A1
(43) Pub. Date: Aug. 24, 2006

(54) Resin composition

(76) Inventors: Edward M. Dexheimer, Grosse Ile, MI (US); Raymond A. Neff, Northville, MI (US)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 11/062,137

(22) Filed: Feb. 18, 2005

(51) Int. Cl. C08J 9/00

(52) U.S. Cl. 521/99

(57) ABSTRACT

A resin composition includes a polyol and is used to form flexible foams. The resin composition also includes water and an alkoxylate of an active hydrogen containing species. The alkoxylate of the active hydrogen containing species acts in two separate ways. The alkoxylate acts as a blowing reaction modifier, thus maintaining slow-blow behavior of a foaming process that accompanies a reaction of the polyol with an isocyanate. The alkoxylate also acts as a compatibilizer. As the compatibilizer, the alkoxylate stabilizes the resin composition such that no phase separation occurs between the polyol, the water, and the alkoxylate. Stabilizing the resin composition allows for multiple day storage of the resin composition with no phase separation, thus extending useable shelf life and reducing production costs. Stabilizing the resin composition also allows for formation of flexible foams with consistent physical properties such as flexibility.

### FIELD OF THE INVENTION

The subject invention generally relates to a resin composition primarily used to form a flexible foam. More specifically, the subject invention relates to a resin composition that includes a polyol, water, and an alkoxylate of an active hydrogen containing species that acts as a compatibilizer to stabilize the resin composition.

### DESCRIPTION OF THE RELATED ART

Various resin compositions have been investigated for use in industrial processes as precursors to formation of both flexible and rigid polyurethane foams and have been used in a wide variety of applications. Flexible polyurethane foams can be utilized in many applications including automobile seat and automobile trim applications such as head and arm rests. Rigid polyurethane foams can be utilized in applications including insulation and as a strengthening material for a composite article. Choice of the resin composition is dependent on the aforementioned applications, and thus, careful choice of the resin composition is necessary.

Many resin compositions include a polyol and a blowing agent. Yet, the polyol and the blowing agent may not be compatible. Polarities of the polyol and the blowing agent may be dissimilar resulting in phase separation of the polyol and the blowing agent, when combined. If glycerin and water are present, the high polarity of the glycerin and the water will promote phase separation to occur when the glycerin and the water are mixed with the polyol which is of a lower polarity. Phase separation within the resin composition leads to a formation of commercially unusable foams with a variety of defects due to a lack of homogeneity of the resin composition.

Attempts have been made to overcome issues of phase separation in resin compositions used to form rigid foams. However, no successful attempts have been made to overcome issues of phase separation in resin compositions used to form flexible foams. Attempts that have failed include use of silicone surfactants to stabilize the resin composition.

The attempts that have been made with regard to the rigid foams utilize low polarity blowing agents such as carbon dioxide and chlorofluorocarbons (CFCs). Yet, use of carbon dioxide and CFCs occasionally results in rigid foams that do not have acceptable physical properties. Also, use of CFCs has become subject to increased criticism and regulation due to environmental concerns.

Other efforts have been made in an attempt to overcome issues of phase separation in resin compositions used to form rigid foams through use of high polarity blowing agents such as water and glycerin. Yet, use of water and glycerin, when combined with the polyol, still promotes phase separation. Because use of water and glycerin still promotes phase separation in rigid foam applications, ethoxylates of active hydrogen containing species have been used in another attempt to solve the issues of phase separation and form rigid foams with increased insulating properties and high core strengths.

One attempt to solve the issues of phase separation in resin compositions used to form rigid foams is disclosed in U.S. Pat. No. 5,373,030 to Kaplan et al. The '030 patent discloses use of a polyisocyanate, an ethoxylate of an active hydrogen containing species, water, and a polyol having a molecular weight of from 40 to 400. The '030 patent also discloses that use of the ethoxylate of the active hydrogen containing species in the resin composition allows the rigid foams to have greater insulating properties due to a prevention of airflow into the foam, thereby forming a more dense and rigid foam. The '030 patent does not disclose polyols having a higher molecular weight of from 2,000 to 6,000 because higher molecular weight polyols are typically not suitable for use in rigid foam applications. It is known that higher molecular weight polyols have longer carbon chains and thus form flexible foams and foams with decreased core strength when the polyols are reacted with isocyanates. Also, the '030 patent does not disclose the ethoxylate of the active hydrogen containing species included in a resin composition used to form a flexible foam that allows air to pass in and through. The '030 patent discloses exactly the opposite, in which the rigid foams formed are resistive to air flow and have increased density. Resin compositions that include the polyols disclosed in the '030 patent are unsuitable for use in flexible foam applications.

A second attempt to solve the issues of phase separation in resin compositions is disclosed in U.S. Pat. No. 4,289,858 to Koehler et al. The '858 patent discloses use of an amine based polyol, blowing agents such as CFCs and water, and an ethoxylate of an active hydrogen containing species used to form high core strength laminate foams. The '858 patent discloses that the ethoxylate of the active hydrogen containing species has a molecular weight of from 60 to 1,000. The '858 patent also discloses that the amine based polyols react with isocyanates to form rigid foams. The '858 patent does not disclose a polyol having a higher molecular weight of from 2,000 to 6,000 because, similar to the '030 patent described above, higher molecular weight polyols are not suitable for use in rigid foam applications. Also, the '858 patent does not disclose the ethoxylate of the active hydrogen containing species forming a flexible foam that has little core strength. The '858 patent, like the '030 patent, discloses exactly the opposite. The '858 patent discloses a formation of a foam with high core strength that is bonded to facer material. Therefore, the '858 patent is not suitable for use in flexible foam applications where flexible foams with decreased core strength are required.

The resin compositions, as described above, have been used in rigid or laminate foam applications. These resin compositions are not suitable for use in flexible foam applications for various reasons. The low molecular weight polyols form foams that have a high cross-linking density that does not allow for flexibility or movement of the foam. Also, the resin compositions are used to form foams that have properties such as increased core strength and resilience to applied pressure which are detrimental to flexible foams. Inclusion of those properties would transform a flexible foam into a rigid foam.

### SUMMARY OF THE INVENTION AND ADVANTAGES

The subject invention provides a resin composition including a polyol. The polyol has a molecular weight from 2,000 to 6,000 g/mol. The polyol also has a hydroxyl number of from 10 to 60 mg KOH/g. The resin composition also includes water and an alkoxylate of an active hydrogen containing species. The alkoxylate has at least three hydroxyl groups, from 0.3 to 2.0 alkylene oxide groups per hydroxyl group of the active hydrogen containing species, and a hydroxyl number of at least 350 mg KOH/g.

The subject invention can generally be used for formation of flexible foams. Specifically, the alkoxylate of the active hydrogen containing species acts in two separate ways. The alkoxylate acts as a blowing reaction modifier, replacing other blowing reaction modifiers such as glycerin. As a blowing reaction modifier, the alkoxylate maintains slow-blow behavior of a foaming process that accompanies a reaction of the polyol with an isocyanate used to form the flexible foam. The slow-blow behavior of the foaming process is critical to formation of certain flexible foams because it improves a flow-ability of the resin.

The alkoxylate also acts as a compatibilizer. As the compatibilizer, the alkoxylate stabilizes the resin composition preventing phase separation of the polyol from the water and the alkoxylate. Stabilizing the resin composition allows the resin composition to be stored over time without phase separation, thus extending useable shelf life of the resin composition and reducing production costs. Also, stabilizing the resin composition allows for the formation of a flexible foam with consistent physical properties.

### DETAILED DESCRIPTION OF A PREFERRED EMBODIMENT

A resin composition, according to the present invention, is used in industrial production of a variety of flexible foams. The flexible foams are used in applications where rigid foams would be inappropriate such as in automobile seats and in automobile trim components such as head and arm rests. The flexible foams cannot have high core strengths and still allow air to pass in and through to retain flexibility and ventilation.

Typically, the flexible foams are formed through a reaction of a polyol and an isocyanate reactive with the polyol. The resin composition of the subject invention includes a polyol, water, and an alkoxylate of an active hydrogen containing species. The water and the alkoxylate are described additionally below.

The polyol of the resin composition is typically used in industrial processes to react with an isocyanate to form polyurethane flexible foams, as in known in the art. The polyol of the resin composition preferably includes, but is not limited to, polyether polyols, polyester polyols, and combinations thereof. Most preferably, the polyol includes a polyether polyol.

To form the polyol, typically, low molecular weight di- or poly-functional alcohols or amines are used as initiators. Preferably, to form the polyol of the present invention, the initiator has a functionality of from 2 to 6 and more preferably of from 3 to 5. Most preferably, the initiator has a functionality of 3 and includes glycerin. Other initiators having a functionality of three include trimethylol-alkanes such as 1,1,1-trimethylolpropane. It is contemplated that combinations of the initiators may be utilized.

Typically, the initiator serves as a reactant that reacts with an alkylene oxide to form the polyol. Molecules of the alkylene oxide preferably form a plurality of internal blocks in the polyol and also form a plurality of terminal blocks attached to the plurality of internal blocks in the polyol. The alkylene oxide includes, but is not limited to, ethylene oxide, propylene oxide, butylene oxide, and combinations thereof. In the subject invention, the polyol preferably includes a plurality of internal blocks formed from propylene oxide. It is contemplated that the plurality of internal blocks may be in a heteric formation, i.e., random blocks formed from propylene oxide, ethylene oxide, and/or butylene oxide. At a minimum, it is preferred that the internal blocks have 50 parts by weight of propylene oxide per 100 parts by weight of the polyol.

The polyol may also include a plurality of terminal blocks, i.e., terminal caps, attached to the plurality of internal blocks. The terminal caps are formed from ethylene oxide. The terminal caps preferably have of from 5.0 to 25.0, more preferably of from 10.0 to 20.0, and most preferably of from 12.0 to 18.0, parts by weight of ethylene oxide per 100 parts by weight of the internal blocks.

Once the polyol is formed from the reaction of the initiator and the alkylene oxides, the polyol preferably has a weight average molecular weight, M_{w}, of from 2,000 to 6,000, more preferably of from 3,000 to 6,000, and most preferably of from 5,000 to 6,000, g/mol. The polyol also preferably has a hydroxyl number of from 10 to 60, more preferably of from 20 to 60, and most preferably of from 30 to 60 mg KOH/g. The polyol also preferably has a hydroxyl functionality of from 2 to 8, more preferably of from 3 to 6, and most preferably of from 3 to 4. The polyol also preferably has a viscosity of from 200 to 10,000, more preferably of from 200 to 6,000, and most preferably of from 600 to 6,000, centipoises at 70° F. It is preferred that the polyol is present in the resin composition in an amount of from 10.0 to 90.0 and most preferably of from 15.0 to 85.0, parts per one hundred parts polyol.

Generally, the polyol may include a dispersion of addition polymers, i.e., a graft polyol. Specifically, the polyol may be a dispersion of addition polymers that includes microscopic particles of styrene, acrylonitrile, and combinations thereof. If included, the dispersions are preferably included in an amount of from 0.1 to 50.0, more preferably of from 25.0 to 50.0, and most preferably of from 45.0 to 50.0 parts by weight per 100, parts by weight of the polyol. An example of a suitable polyol includes, but is not limited to, PLURACOL® polyol 1528 which is commercially available from BASF Corporation.

Referring now to the water introduced above, the water serves as a blowing agent in the reaction of the polyol and the isocyanate, as is known in the art. Preferably, the water is present in the resin composition in an amount of from 2.0 to 6.0, more preferably of from 3.0 to 5.0, and most preferably of from 4.0 to 4.5, parts per hundred polyol. If included in the resin composition without traditional blowing reaction modifiers such as glycerin, a blowing reaction proceeds faster, resulting in poor foam flow-ability, and potentially forms flexible foams that have undesirable properties such as voids and depressions. Therefore, an improved blowing reaction modifier is also typically employed in the resin composition.

Referring now to the alkoxylate of an active hydrogen containing species, as introduced above, the alkoxylate generally serves as the improved blowing reaction modifier in the reaction of the polyol and the isocyanate and also as a compatibilizer of the resin composition.

Acting as the improved blowing reaction modifier, the alkoxylate replaces the traditional blowing reaction modifier such as glycerin that, when added to the polyol and the water, promotes immediate phase separation due to a higher polarity as compared to the polyol. As the improved blowing reaction modifier, the alkoxylate also maintains slow-blow behavior of a foaming process. The foaming process accompanies the reaction of the polyol with the isocyanate reactive with the polyol that is used to form the flexible foam. The slow-blow behavior of the foaming process is critical to formation of the flexible foam because it allows a foam to be molded into a variety of shapes and allows the foam to remain porous and flexible.

Acting as the compatibilizer, the alkoxylate generally serves to stabilize the resin composition into one phase. Specifically, the alkoxylate stabilizes the polyol, the water, and the alkoxylate without any phase separation. Without intending to be bound or limited by any particular theory, it is believed that alkoxy functionality of the active hydrogen containing species allows the species to be compatible with oxygen present in the polyol and the water. It is also believed that the organic functionality of the active hydrogen containing species allows the active hydrogen containing species to be compatible with carbon present in the polyol. Thus, the alkoxylate serves to compatibilize the resin composition.

Preferably, the alkoxylate includes ethoxylates, propoxylates, butoxylates, and combinations thereof. More preferably, the alkoxylate includes an ethoxylate. Most preferably, the alkoxylate includes glycerin ethoxylate, 1,1,1-trimethylolpropane ethoxylate, and combinations thereof.

Further, the alkoxylate has at least three hydroxyl groups. Preferably, the alkoxylate has from three to eight hydroxyl groups. More preferably the alkoxylate has from four to eight hydroxyl groups. Most preferably, the alkoxylate has three hydroxyl groups. Still further, the alkoxylate has from 0.3 to 2.0 alkylene oxide groups per hydroxyl group of the active hydrogen containing species. More preferably, the alkoxylate has from 0.3 to 1.5 and most preferably from 0.3 to 1.0 alkylene oxide groups per hydroxyl group of the active hydrogen containing species.

Additionally, the alkoxylate has a hydroxyl number of at least 350 mg KOH/g. More preferably, the alkoxylate has a hydroxyl number of from 400 to 1300 mg KOH/g. Most preferably, the alkoxylate has a hydroxyl number of from 600 to 800 mg KOH/g. Further, the alkoxylate preferably has a molecular weight, M_{w}, of at least 130 g/mol. Most preferably, the alkoxylate has a molecular weight of from 200 to 450 g/mol. Alkoxylates with these hydroxyl numbers and these molecular weights stabilize the resin composition.

It is to be understood that alkoxylates with high molecular weights, especially alkoxylates with molecular weights of greater than 500 g/mol, are not suitable for use in the resin composition of the present invention. Such alkoxylates with these higher molecular weights are not effective compatibilizers because they destabilize the resin composition. More specifically, the alkoxylates with high molecular weights are known to function as reactive polyols in the resin composition and have a low polarity which promotes phase separation of the resin composition. The alkoxylates with high molecular weights are also not effective blowing reaction modifiers because they cannot be used to replace glycerin.

The alkoxylate of the present invention is preferably present in the resin composition in an amount of from 0.5 to 15, more preferably of from 0.5 to 10 and most preferably of from 0.5 to 6 parts per one hundred parts polyol.

The active hydrogen containing species preferably includes alcohols, amines, and combinations thereof. Most preferably, the hydrogen containing species includes 1,1,1-trimethylolpropane, glycerin, and combinations thereof.

The resin composition may also include a second polyol, different from the polyol. The second polyol, although different, has the same range of physical properties as the polyol. If the second polyol is included in the resin composition, it is preferred that the second polyol is present in the resin composition in an amount of from 1.0 to 100.0, more preferably of from 10.0 to 90.0, and most preferably of from 15.0 to 85.0, parts per one hundred parts polyol.

The resin composition may also include a cross-linker. The cross-linker may include, but is not limited to, amines, a third polyol different from the polyol and the second polyol, and combinations thereof. If the resin composition includes the amines as the cross-linker, the amines preferably include diethanolamine, triethanolamine, ethylene diamine alkoxylation products having hydroxyl numbers greater than 250 mg KOH/g, and combinations thereof. If the resin composition includes the third polyol, the third polyol preferably has a hydroxyl number of greater than 250 mg KOH/g and a functionality of greater than 2.

If the cross-linker is included in the resin composition without the alkoxylate, the cross-linker promotes phase separation. However, the alkoxylate used in the resin composition of the present invention stabilizes the resin composition including the diethanolamine.

The resin composition may also include a surfactant. The surfactant serves as a supplemental compatibilizer to stabilize the resin composition. The surfactant may be a non-ionic surfactant. The surfactant preferably includes, but is not limited to, polyoxyalkylene polyol surfactants, alkylphenol ethoxylate surfactants, and combinations thereof. More preferably, the surfactant includes, but is not limited to, commercial surfactants including Pluronic® polyethers and Tetronic® polyethers as the polyoxyalkylene polyol surfactants, Iconol® surfactants as the alkylphenol ethoxylate surfactants, and combinations thereof. The surfactants are supplied by the BASF Corporation of Wyandotte, Mich. Most preferably, the surfactants include Pluronic® L-61, Pluronic® 31 R1, Tetronic® 701, Iconol® OP-3, and combinations thereof.

More specifically, the Pluronic® polyethers are block co-polymer condensates of ethylene oxide and propylene oxide. Generally, there are two types of Pluronic® polyethers. A first type of Pluronic® polyether includes a hydrophobic base formed by condensing propylene oxide with propylene glycol to yield an internal block formed from propylene oxide and two terminal blocks formed from ethylene oxide that are attached to the plurality of internal blocks. The first type of Pluronic® polyether typically has a weight average molecular weight, M_{w}, of from 1,000 to 20,000 g/mol, has a hydrophilic/lipophilic balance (HLB) of from 1-28, and includes the general structure:
HO(C₂H₄O)ₐ(C₃H₆O)_{b}(C₂H₄O)ₐH
wherein a is an integer of from 2 to 250, and wherein b is an integer of from 15 to 70.

A second type of Pluronic® polyether, a Pluronic®-R polyether, includes a hydrophilic base formed by condensing ethylene oxide with ethylene glycol to yield an internal block formed from ethylene oxide and two terminal blocks formed from propylene oxide that are attached to the plurality of internal blocks. Pluronic®-R polyethers typically have a weight average molecular weight, M_{w}, of from 1,000 to 20,000 g/mol, an HLB of from 1-28, and include the general structure:
HO(C₃H₆O)ₐ(C₂H₄O)_{b}(C₃H₆O)ₐH
wherein a is an integer of from 5 to 25, and wherein b is an integer of from 5 to 150.

Also more specifically, the Tetronic® polyethers are block co-polymer condensates of propylene oxide, ethylene diamine, and ethylene oxide. The Tetronic® polyethers have a plurality of internal blocks formed from propylene oxide and a plurality of terminal blocks formed from ethylene oxide that are attached to the plurality of internal blocks. The Tetronic® polyethers typically have a weight average molecular weight, M_{w}, of from 1,000 to 40,000 g/mol and include the general structure: 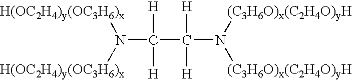
wherein x is an integer of from 15 to 120 and wherein y is an integer of from 3 to 600. Typically, the Tetronic® polyethers have an HLB of from 1-30.

If the polyoxyalkylene polyol surfactants are included in the resin composition, it is preferred that the polyalkyelene polyol surfactants are present in the resin composition in an amount of from 1.0 to 10.0, more preferably of from 2.0 to 8.0, and most preferably of from 4.0 to 6.0 percent by weight of the resin composition.

Further, and more specifically, the Iconol® surfactants include alkylphenol ethoxylate surfactants including a central phenolic core. The central phenolic core includes an alkyl ligand and an ethoxylate ligand. Most preferably the alkylphenol ethoxylate surfactant includes, but is not limited to, octylphenol ethoxylate, nonylphenol ethoxylate, and combinations thereof. The Iconol® surfactants that are alkylphenol ethoxylate surfactants typically have a molecular weight of from 280 to 4,000 g/mol and include the general structure: 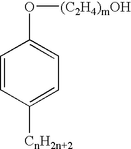
wherein m is an integer of from 1 to 100, and where n is an integer of from 8 to 9. Typically the Iconol® surfactants have an HLB of from 4-20.

If the alkylphenol ethoxylate surfactant is included in the resin composition, it is preferred that the alkylphenol ethoxylate surfactant is present in the resin composition in an amount of from 0.1 to 5.0, more preferably of from 1.0 to 5.0, and most preferably of from 1.5 to 3.5, percent by weight of the resin composition.

The resin composition may also include a blowing catalyst. The blowing catalyst serves to increase a speed of a reaction between the isocyanate and the water to form carbon dioxide, as is known in the art. The blowing catalyst preferably includes, but is not limited to, amines. More preferably, the blowing catalyst includes amine catalysts such as Niax amine catalysts. Most preferably, the blowing catalyst includes Niax A1 amine catalyst which includes 2,2-oxybis(N,N-dimethylethylamine). If the blowing catalyst is included in the resin composition, the blowing catalyst is preferably included in an amount of from 0.01 to 0.15, more preferably of from 0.05 to 0.10, and most preferably of from 0.07 to 0.09, parts per one hundred parts polyol. It is contemplated that other blowing catalysts may be used by those skilled in the art.

Further, the resin composition may also include a gelling catalyst. The gelling catalyst promotes a reaction between the polyol and the isocyanate to form the polyurethane. The gelling catalyst preferably includes, but is not limited to, amines. More preferably, the gelling catalyst includes tertiary amines such as DABCO amine catalysts. Most preferably, the gelling catalyst includes DABCO amine catalysts such as Dabco 33 LV amine catalyst which includes a combination of triethylene diamine and dipropylene glycol. If included in the resin composition, the gelling catalyst is preferably included in an amount of from 0.10 to 0.30, more preferably of from 0.15 to 0.25, and most preferably of from 0.20 to 0.25, parts per one hundred parts polyol.

Still further, the resin composition may include a foam surfactant. The foam surfactant serves to control cell size of the flexible foam produced from the reaction of the polyol and the isocyanate. The foam surfactant preferably includes, but is not limited to, bulk and surface silicone surfactants. The foam surfactants are commercially available from Dow Corning of Midland, Mich. and most preferably include silicone surfactants such as DC 5164, DC 5169, and combinations thereof. If included in the resin composition, the foam surfactant is preferably included in an amount of from 0.10 to 1.0, more preferably of from 0.20 to 0.80, and most preferably of from 0.30 to 0.70 parts per one hundred parts polyol.

### EXAMPLES

A resin composition including an alkoxylate as a compatibilizer was formed according to the subject invention. An experimental resin composition was also formed that did not include the alkoxylate as the compatibilizer. The experimental resin composition included glycerin as a traditional blowing reaction modifier, in place of the alkoxylate. The resin compositions including the alkoxylate and the experimental resin composition lacking the alkoxylate were visually evaluated to determine if phase separation occurred after the resin compositions were allowed to stand overnight at room temperature (70° F./21° C.).

Specific components included in both the resin compositions including the alkoxylate and in the experimental resin composition are set forth in Table 1. All components are in parts per one hundred parts polyol unless otherwise noted. Further, any percentages indicated in Table 1 are based on 100 parts of the total resin composition.

TABLE 1

| Resin Composition | | Comparative |
|---|---|---|
| Component | Ex. 1 RC | Example 1 RC |
| First Polyol | 84 | 84 |
| Second Polyol | 16 | 16 |
| Compatibilizer | 0.9 | |
| Glycerin | | 0.9 |
| Diethanolamine | 0.7 | 0.7 |
| Water | 4.2 | 4.2 |
| Blowing Catalyst | 0.08 | 0.08 |
| Gelling Catalyst | 0.23 | 0.23 |
| Foam Surfactant 1 | 0.7 | 0.7 |
| Foam Surfactant 2 | 0.3 | 0.3 |
| Overnight Phase Separation | None | Yes |

RC, in Example 1, is the resin composition including the alkoxylate as the compatibilizer. RC, in comparative example 1, is the experimental resin composition, described in greater detail below that does not include the alkoxylate as the compatibilizer. Both the resin composition including the alkoxylate as the compatibilizer and the experimental resin composition were created in a master batch with the resin composition components including first polyol, the second polyol, the diethanolamine, the water, the blowing catalyst, the gelling catalyst, the foam surfactant 1, and the foam surfactant 2. The master batch was created by adding all the resin composition components to a vessel and mixing with an electric stirrer. A first sample was removed and alkoxylate (i.e., compatibilizer) was added to the first sample to form the resin composition including the alkoxylate. A second sample was also removed and glycerin was added to the second sample to form the experimental resin composition. Each of the two samples were shaken by hand to ensure adequate mixing.

First Polyol is a glycerin initiated polyether polyol having a weight average molecular weight, M_{w}, of 3700 g/mol, a hydroxyl number of 45 mg KOH/g, a viscosity of 600 centipoises at 70° F., a functionality of three, and a 12% ethylene oxide terminal cap.

Second Polyol is a glycerin initiated polyether polyol having a weight average molecular weight, M_{w}, of 4200 g/mol, a hydroxyl number of 19 mg KOH/g, a viscosity of 5900 centipoises at 70° F., a functionality of three, an 18% ethylene oxide terminal block, and a 45% addition of addition polymers.

Compatibilizer is an ethoxylate of 1,1,1-trimethylolpropane formed by a method well known in the art. Specifically, the ethoxylate of 1,1,1-trimethylolpropane was formed by adding the 1,1,1-trimethylolpropane to a vessel with potassium hydroxide as a catalyst. Ethylene oxide was then added to the vessel to complete the reaction and form the ethoxylate of 1,1,1-trimethylolpropane.

Glycerin is commercially available from Procter and Gamble under the trade name of Superol®.

Diethanolamine is a mixture including 20 parts by weight of water per 100 parts by weight of the mixture and 80 parts by weight of diethanolamine per 100 parts by weight of the mixture.

Blowing catalyst is 2,2-oxybis(N,N-dimethylethylamine) commercially available under the trade name of Niax® A1 amine catalyst.

Gelling catalyst is a combination of 33% triethylene diamine and 67% dipropylene glycol. The gelling catalyst is commercially available under the trade name of DABCO 33 LV amine catalyst.

Foam surfactant 1 is a bulk silicone surfactant commercially available from the Dow Corning Corporation of Midland, Mich., under the trade name of DC 5164.

Foam surfactant 2 is a surface silicone surfactant commercially available from the Dow Corning Corporation of Midland, Mich., under the trade name of DC 5169.

The experimental resin composition, as introduced above, includes:
the first polyol;
the second polyol;
the glycerin;
the diethanolamine;
the water;
the blowing catalyst;
the gelling catalyst;
the foam surfactant 1; and
the foam surfactant 2.

Overnight phase separation is a visual evaluation of the resin compositions introduced above. The visual evaluation was performed after the resin compositions were allowed to stand overnight at room temperature (70° F./21° C.) and used to determine if the resin compositions exhibited phase separation. Upon visual evaluation, the resin composition including the alkoxylate as the compatibilizer was determined not to exhibit phase separation when allowed to stand overnight at room temperature (70° F./21° C.) Conversely, the experimental resin composition that did not include the alkoxylate as the compatibilizer was determined to exhibit phase separation when allowed to stand overnight at room temperature (70° F./21° C.).

Additionally, a subject polyurethane foam, as set forth in Example 1 of Table 2, was formed. Further, an experimental foam was also formed and is also set forth in Comparative Example 1 of Table 2. The experimental foam was formed using the experimental resin composition of the Comparative Example 1 in Table 1. The subject polyurethane foam and the experimental foam were visually evaluated to determine if voids were present in the foams.

Specific components included in both the subject polyurethane foam of Example 1 and the experimental foam of Comparative Example 1 are set forth in Table 2. All components are in parts per one hundred parts polyol unless otherwise noted.

TABLE 2

| | | Comparative |
|---|---|---|
| | | Example 1 |
| | Ex. 1 Foam | Foam |
| Resin Composition Component | | |
| First Polyol | 84 | 84 |
| Second Polyol | 16 | 16 |
| Compatibilizer | 1.8 | |
| Glycerin | | 0.9 |
| Diethanolamine | 0.7 | 0.7 |
| Water | 4.2 | 4.2 |
| Blowing Catalyst | 0.08 | 0.08 |
| Gelling Catalyst | 0.23 | 0.23 |
| Foam Surfactant 1 | 0.7 | 0.7 |
| Foam Surfactant 2 | 0.3 | 0.3 |
| Isocyanate Composition Component | | |
| Isocyanate | 52 | 52 |
| Isocyanate Index | 100 | 100 |
| Visual Appearance of Foam | No Voids | No Voids |
| (Voids/No Voids) | | |

Foam, in Example 1 is the subject polyurethane foam formed from a reaction of an isocyanate, described in greater detail below, and the resin composition formed according to the subject invention. Foam, in Comparative Example 1, is the experimental foam formed from a reaction of the isocyanate and the experimental resin composition that does not include the alkoxylate as the compatibilizer.

The foams, in both Example 1 and Comparative Example 1, were formed by standard hand-mix technique, as is known in the art. The foams were poured into a 15×15×4 in³ rectangular heated mold at 65° C. and de-molded after 6 minutes.

Isocyanate is toluene diisocyanate, commercially available from BASF Corporation of Wyandotte Mich.

Isocyanate index is a ratio of an amount of the isocyanate that was used, to a theoretical amount of the isocyanate required to form the foam, multiplied by 100.

Visual Appearance of Foam is a visual evaluation of the foams formed, including the subject polyurethane foam of Example 1 and the experimental foam of Comparative Example 1. The visual evaluation was performed to determine if voids were present in the foams. Upon visual evaluation, neither the subject polyurethane foam of Example 1 nor the experimental foam of Comparative Example 1 was determined to have voids. Therefore, the subject polyurethane foam of Example 1, formed from the resin composition including the alkoxylate as the compatibilizer, was visually identical to the experimental foam of Comparative Example 1, formed from the experimental resin composition that did not include the alkoxylate as the compatibilizer.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

What is claimed is:

1. A resin composition comprising:
(A) a polyol having a molecular weight of from 2,000 to 6,000 g/mol and a hydroxyl number of from 10 to 60 mg KOH/g;
(B) water; and
(C) an alkoxylate of an active hydrogen containing species, said alkoxylate having at least three hydroxyl groups, from 0.3 to 2.0 alkylene oxide groups per hydroxyl group of said active hydrogen containing species, and a hydroxyl number of at least 350 mg KOH/g.

2. A resin composition as set forth in claim 1 wherein said polyol has a molecular weight of from 3,000 to 6,000 g/mol.

3. A resin composition as set forth in claim 1 wherein said polyol has a molecular weight of from 5,000 to 6,000 g/mol.

4. A resin composition as set forth in claim 1 wherein said polyol has a hydroxyl number of from 20 to 60 mg KOH/g.

5. A resin composition as set forth in claim 1 wherein said polyol has a hydroxyl number of from 30 to 60 mg KOH/g.

6. A resin composition as set forth in claim 1 wherein said alkoxylate is present in the resin composition in an amount of from 0.5 to 10 parts per one hundred parts polyol.

7. A resin composition as set forth in claim 1 wherein said alkoxylate is selected from the group of ethoxylates, propoxylates, butoxylates, and combinations thereof.

8. A resin composition as set forth in claim 7 wherein said alkoxylate comprises an ethoxylate.

9. A resin composition as set forth in claim 8 wherein said ethoxylate is selected from the group of glycerin ethoxylate, 1,1,1-trimethylolpropane ethoxylate, and combinations thereof.

10. A resin composition as set forth in claim 8 wherein said ethoxylate comprises glycerin ethoxylate.

11. A resin composition as set forth in claim 8 wherein said ethoxylate comprises 1,1,1-trimethylolpropane ethoxylate.

12. A resin composition as set forth in claim 1 wherein said alkoxylate has from four to eight hydroxyl groups.

13. A resin composition as set forth in claim 1 wherein said alkoxylate has of from 0.3 to 1.5 alkylene oxide groups per hydroxyl group of said active hydrogen containing species.

14. A resin composition as set forth in claim 1 wherein said alkoxylate has of from 0.3 to 1.0 alkylene oxide groups per hydroxyl group of said active hydrogen containing species.

15. A resin composition as set forth in claim 1 wherein said resin composition further comprises a second polyol, different from said polyol, having a molecular weight of from 2,000 to 6,000 g/mol, and a hydroxyl number of from 10 to 60 mg KOH/g.

16. A resin composition as set forth in claim 15 wherein said second polyol has a molecular weight of from 3,000 to 6,000 g/mol.

17. A resin composition as set forth in claim 15 wherein said second polyol has a molecular weight of from 5,000 to 6,000 g/mol.

18. A resin composition as set forth in claim 15 wherein said second polyol has a hydroxyl number of from 20 to 60 mg KOH/g.

19. A resin composition as set forth in claim 15 wherein said second polyol has a hydroxyl number of from 30 to 60 mg KOH/g.

20. A resin composition as set forth in claim 1 wherein said resin composition further comprises a surfactant.

21. A resin composition as set forth in claim 20 wherein said surfactant is selected from the group of polyoxyalkylene polyol surfactants, alkylphenol ethoxylate surfactants, and combinations thereof.

22. A resin composition as set forth in claim 21 wherein said polyoxyalkylene polyol surfactants comprise the general structure:
HO(C₂H₄O)ₐ(C₃H₆O)_{b}(C₂H₄O)ₐH
wherein a is an integer of from 2 to 250; and
wherein b is an integer of from 15 to 70.

23. A resin composition as set forth in claim 21 wherein said polyoxyalkylene polyol surfactants comprise the general structure:
HO(C₃H₆O)ₐ(C₂H₄O)_{b}(C₃H₆O)ₐH
wherein a is an integer of from 5 to 25; and
wherein b is an integer of from 5 to 150.

24. A resin composition as set forth in claim 21 wherein said polyoxyalkylene polyol surfactants comprise the general structure: 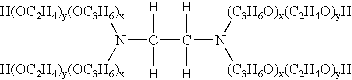
wherein x is an integer of from 15 to 120; and
wherein y is an integer of from 3 to 600.

25. A resin composition as set forth in claim 21 wherein said alkylphenol ethoxylate surfactants comprise the general structure: 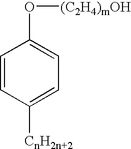
wherein m is an integer of from 1 to 100; and
wherein n is an integer of from 8 to 9.

26. A resin composition as set forth in claim 21 wherein said polyoxyalkylene polyol surfactants are present in said resin composition in an amount of from 1.0 to 10.0 parts by weight per 100 parts by weight of said resin composition.

27. A resin composition as set forth in claim 21 wherein said polyoxyalkylene polyol surfactants are present in said resin composition in an amount of from 2.0 to 8.0 parts by weight per 100 parts by weight of said resin composition.

28. A resin composition as set forth in claim 21 wherein said alkylphenol ethoxylate surfactants are present in said resin composition in an amount of from 0.1 to 5.0 parts by weight per 100 parts by weight of said resin composition.

29. A resin composition as set forth in claim 21 wherein said alkylphenol ethoxylate surfactants are present in said resin composition in an amount of from 1.0 to 5.0 parts by weight per 100 parts by weight of said resin composition.

30. A resin composition as set forth in claim 1 wherein said resin composition further comprises a blowing catalyst.

31. A resin composition as set forth in claim 30 wherein said blowing catalyst comprises 2,2-oxybis(N,N-dimethylethylamine).

32. A resin composition as set forth in claim 1 wherein said resin composition further comprises a gelling catalyst.

33. A resin composition as set forth in claim 32 wherein said gelling catalyst comprises:
(A) triethylene diamine, and
(B) dipropylene glycol.

34. A resin composition as set forth in claim 1 wherein said resin composition further comprises a foam surfactant.

35. A resin composition as set forth in claim 34 wherein said foam surfactant comprises a silicone surfactant.

36. A resin composition as set forth in claim 1 that is free of glycerin.

37. A resin composition as set forth in claim 1 further comprising a cross-linker.

38. A resin composition as set forth in claim 37 wherein said cross-linker is selected from the group of amines, a third polyol different from said polyol, and combinations thereof.

39. A resin composition as set forth in claim 38 wherein said cross-linker comprises diethanolamine.

40. A resin composition as set forth in claim 1 wherein said alkoxylate has a hydroxyl number of from 400 to 1300 mg KOH/g.

41. A resin composition as set forth in claim 40 wherein said alkoxylate has a hydroxyl number of from 600 to 800 mg KOH/g.

42. A resin composition as set forth in claim 1 wherein said alkoxylate has a molecular weight, M_{w}, of at least 130 g/mol.

43. A resin composition as set forth in claim 42 wherein said alkoxylate has a molecular weight, M_{w}, of from 200 to 450 g/mol.
